(19) United States
(12) Patent Application Publication
(10) Pub. No.: US 2010/0085676 A1
(43) Pub. Date: Apr. 8, 2010

(54) NESTED PULSE WIDTH MODULATION CONTROL

(75) Inventor: Russell Wilfert, Chandler, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/245,495

(22) Filed: Oct. 3, 2008

(51) Int. Cl. H01H 47/00

(52) U.S. Cl. 361/170

(57) ABSTRACT

A PWM control circuit includes a first PWM driver, a duty cycle compensator, and a second PWM driver. The first PWM driver receives duty cycle commands and generates a first PWM driver signal having a duty cycle that varies based on the duty cycle commands. The duty cycle compensator receives the first PWM driver signal and a sensor signal representative of a value of a sensed physical parameter. The duty cycle compensator supplies compensated duty cycle commands based on the duty cycle of the first PWM driver signal and the value of the sensed physical parameter. The second PWM driver receives the compensated duty cycle commands and generates a hybrid PWM driver signal having a duty cycle that varies based on the compensated duty cycle commands. The resulting hybrid signal provides improved resolution for control that cannot be provided by a single PWM driver alone.

### TECHNICAL FIELD

The present invention generally relates to pulse width modulation (PWM) control and, more particularly, to a nested PWM control scheme for components, such as solenoid valves, which are used to control pressurized air flow to a machine, such as a turbine engine starter.

### BACKGROUND

An air turbine starter, as is generally known, may be used to rotate an aircraft gas turbine engine spool. Typically, this is done during a starting sequence of the gas turbine engine. However, an air turbine starter may additionally be used to rotate gas turbine engines during aircraft ground operations for various other reasons. Aircraft gas turbine engines may at times be motored (e.g., rotated without burn fuel flow) while the aircraft is on the ground.

No matter the specific reason for using the air turbine starter to rotate a gas turbine engine, most air turbine starters include a turbine wheel that is rotationally mounted within a housing assembly. The turbine wheel includes an output shaft and, in some instances may additionally include a gear train mechanically coupled between the turbine wheel and the output shaft. The output shaft is mechanically coupled to a spool (e.g., the high pressure spool) of a gas turbine engine through an accessory gearbox mounted to the engine's exterior. To motor the gas turbine engine, pressurized air is supplied to an inlet of the air turbine starter via a valve, such as a solenoid-operated valve. The pressurized air flows past the turbine wheel, causing it to rotate and drive the gas turbine engine.

At times, it may be desirable to control the speed of the gas turbine engine while it is being motored via the air turbine starter. For example, if the gas turbine engine is motored while experiencing, or shortly after experiencing, large internal temperature gradients, speed control may be needed to prevent the turbine blade tips from striking the case. However, controlling air turbine starter speed, and thus gas turbine engine speed, may not be effectually accomplished via, for example, the solenoid-operated valve.

Hence, there is a need for a control scheme that may be used to effectually implement speed control of a machine, such as an air turbine starter for a gas turbine engine, that is powered by pressurized air via a control valve. The present invention addresses at least this need.

### BRIEF SUMMARY

In one embodiment, and by way of example only, a circuit includes a first PWM driver, a duty cycle compensator, and a second PWM driver. The first PWM driver is adapted to receive duty cycle commands and is operable to generate a first PWM driver signal having a duty cycle that varies based on the duty cycle commands. The duty cycle compensator is coupled to receive the first PWM driver signal and a sensor signal representative of a value of a sensed physical parameter. The duty cycle compensator is operable to supply compensated duty cycle commands based on the duty cycle of the first PWM driver signal and the value of the sensed physical parameter. The second PWM driver is coupled to receive the compensated duty cycle commands and is operable to generate a hybrid PWM driver signal having a duty cycle that varies based on the compensated duty cycle commands.

In another exemplary embodiment, a solenoid valve control circuit includes a first PWM driver, a duty cycle compensator, a solenoid PWM driver, and a solenoid valve. The first PWM driver is adapted to receive duty cycle commands and is operable to generate a first PWM driver signal having a duty cycle that varies based on the duty cycle commands. The duty cycle compensator is coupled to receive the first PWM driver signal and a sensor signal representative of a value of a sensed physical parameter. The duty cycle compensator is operable to supply compensated duty cycle commands based on the duty cycle of the first PWM driver signal and the value of the sensed physical parameter. The solenoid PWM driver is coupled to receive the compensated duty cycle commands and is operable to generate a solenoid PWM driver signal having a duty cycle that varies based on the compensated duty cycle commands. The solenoid valve is coupled to receive the solenoid PWM driver signal and is operable, in response thereto, to move between a closed position and an open position at the duty cycle of the solenoid PWM driver signal.

In yet another exemplary embodiment, a control system for controlling the speed of a machine includes a speed sensor, a pressure sensor, a valve, and a controller. The speed sensor is operable to sense the speed of the machine and supply a speed feedback signal representative thereof. The pressure sensor is operable to sense a pressure of a fluid that drives the machine and supply a pressure signal representative thereof. The valve is coupled to receive valve command signals having a duty cycle and is operable, in response thereto, to move between an open position and a closed position at the duty cycle of the valve command signals to thereby control fluid flow to the machine. The controller is coupled to receive a speed command, the speed feedback signal, and the pressure signal and is operable, in response thereto, to supply the valve command signals. The controller includes a comparator, a first PWM driver, a duty cycle compensator, and a valve PWM driver. The comparator is coupled to receive a speed command and the speed feedback signal and is operable, in response thereto, to supply duty cycle commands representative of a difference between the speed command and the speed feedback signal. The first PWM driver is coupled to receive the duty cycle commands and is operable to generate a first PWM driver signal having a duty cycle that varies based on the duty cycle commands. The duty cycle compensator is coupled to receive the first PWM driver signal and the pressure signal. The duty cycle compensator is operable to supply compensated duty cycle commands based on the duty cycle of the first PWM driver signal and the sensed pressure. The valve PWM driver is coupled to receive the compensated duty cycle commands and is operable to supply the valve command signals at a duty cycle that varies based on the compensated duty cycle commands.

Other desirable features and characteristics of the inventive control scheme will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a functional block diagram of a closed-loop air turbine starter speed control system that may embody the present invention;

FIG. 2 is a functional block diagram of a controller that may be used to implement the system of FIG. 1;

FIG. 3 depicts a table of exemplary data that may be used in a lookup table stored in a device used to implement the controller of FIG. 2; and

FIG. 4 depicts an exemplary pulse width modulation (PWM) output signal that may be generated and supplied by the controller of FIG. 2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the control circuit is described in the context of a controller for an air turbine starter of a gas turbine engine to control the speed of the air turbine starter, and thus the gas turbine engine, it will be appreciated that it may be implemented in numerous and other environments and may be used to control the speed of numerous and varied fluid-powered machines.

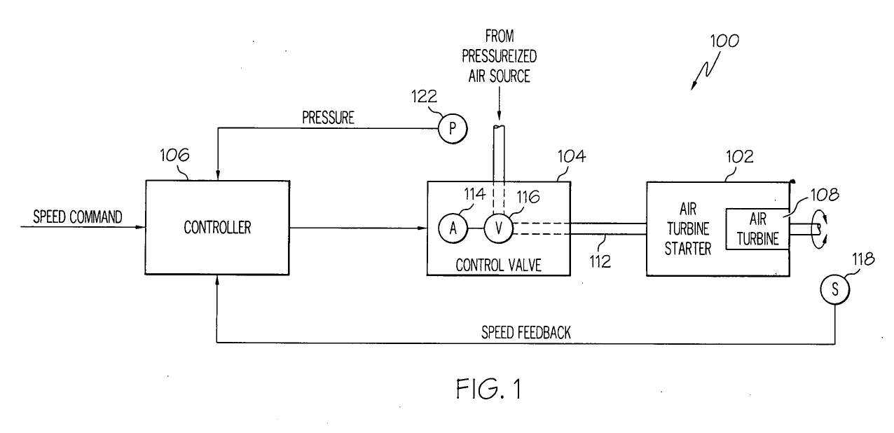

Turning now to FIG. 1, a functional block diagram of an exemplary air turbine starter speed control system 100 is depicted, and includes an air turbine starter 102, a control valve 104, and a controller 106. The air turbine starter 102 includes, among various other components, a rotationally mounted air turbine 108. The air turbine 108 is in turn coupled to a non-illustrated gas turbine engine. The air turbine starter 102 is in fluid communication with the control valve 104 via, for example, a suitable conduit 112, and receives a flow of pressurized air from a non-illustrated pressurized air source via the control valve 104. Upon receipt of the pressurized air, the air turbine 108 rotates and drives the non-illustrated gas turbine engine.

The control valve 104 is disposed between, and is in fluid communication with, the non-illustrated pressurized air source and the air turbine starter 102. The control valve 104 is movable between a closed position and an open position. In the closed position, pressurized air does not flow through the control valve 104 to the air turbine starter 102. In the open position, however, pressurized air does flow through the control valve 104 to the air turbine starter 102. The control valve 104 is responsive to valve command signals it receives from the controller 106 to move between its open and closed positions. It will be appreciated that the control valve 104 may be implemented using any one of numerous types of controllable valves. In a particular preferred embodiment, however, the control valve 104 is a solenoid-operated, dual-position valve that includes a solenoid-piloted actuator 114 coupled to a valve element 1 16. The control valve 104 is configured such that when the solenoid-piloted actuator 114 is energized it moves the valve element 116 to the open position, and when the solenoid-piloted actuator 114 is de-energized it moves the valve element 116 to the closed position. As will now be described, the valve command signals supplied to the control valve 104 comprise pulses having a duty cycle. The control valve 104, in response to these valve command signals, thus moves between its open and closed positions at the duty cycle of the valve command signals to thereby control the flow of pressurized air to the air turbine starter 102.

The controller 106, as was just noted, supplies the valve command signals to the control valve 104. The controller 106 is configured to generate and supply the valve command signals in response to a plurality of input signals. As FIG. 1 depicts, these signals include a speed command, a speed feedback signal, and a pressure signal. The speed command is a signal representative of the desired speed of the air turbine starter 102 and/or gas turbine engine, and is supplied from a non-illustrated circuit or device within, for example, an engine controller. The speed feedback signal is supplied from one or more speed sensors 118, and the pressure signal is supplied one or more pressure sensors 122. In the depicted embodiment, the speed sensor 118, which may be implemented using any one of numerous suitable speed sensing devices, senses the rotational speed of the air turbine starter 102 or non-illustrated engine spool coupled to the air turbine starter 102 and supplies a speed signal representative of the sensed rotational speed to the controller 106 as the speed feedback signal. In the depicted embodiment, the pressure sensor 122, which may be implemented using any one of numerous suitable pressure sensing devices, senses the pressure of the air that drives the air turbine starter 102 and supplies the pressure signal, which is representative of the sensed pressure, to the controller 106. In the depicted embodiment, the pressure sensor 122 senses the pressure of the air upstream of the control valve 104, though it will be appreciated that the pressure at other locations could be sensed.

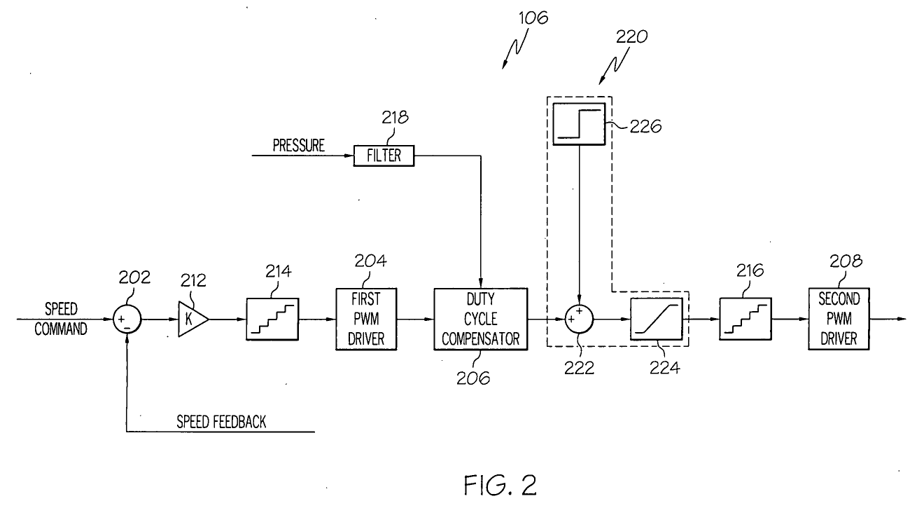

Before proceeding further, it is noted that the pressure of the air that drives the air turbine starter 102 is merely exemplary of just one sensed physical parameter that may be used by the controller 106. For example, if needed or desired, one or more other pressures, one or more temperatures, one or more other speeds, one or more fluid viscosities, one or more chemical contents, just to name a few, could be sensed and supplied to the controller 106. No matter the particular physical parameter that is sensed and used by the controller 106, the controller 106 uses the sensor signal supplied from the suitable sensor in a manner that will be described below. Referring now to FIG. 2, a functional block diagram of an embodiment of the controller 106 is depicted and will now be described.

The controller 106 includes a comparator 202, a first PWM driver 204, a duty cycle compensator 206, and a second PWM driver 208. The comparator 202 is coupled to receive the speed command from the non-illustrated source, and the speed feedback signal from the speed sensor 11 8. The comparator 202, upon receipt of these signals, supplies duty cycle commands representative of the difference between the speed command and the speed feedback signal (i.e., the speed error) to the first PWM driver 204.

The first PWM driver 204 is coupled to receive the duty cycle commands supplied from the comparator 202. The first PWM driver 204 is responsive to these duty cycle commands to generate a first PWM driver signal. The first PWM driver signal, as may be appreciated, comprises pulses having a duty cycle that varies based on the duty cycle commands supplied to the first PWM driver 204. In the depicted embodiment, if the speed error is relatively large, then the duty cycle commands will command the first PWM driver 204 to supply first PWM driver signals having relatively long duty cycles. As the speed error approaches zero, that is, as the sensed speed approaches commanded the speed, the duty cycle commands will command the first PWM driver 204 to supply first PWM driver signals having relatively shorter and shorter duty cycles. In any case, the first PWM driver signals are supplied to the duty cycle compensator 206.

The duty cycle compensator 206 is coupled to receive the first PWM driver signal. As FIG. 2 additionally depicts, the duty cycle compensator 206 also receives the pressure signal from the pressure sensor 122. The duty cycle compensator 206 is configured to be responsive to these signals to supply compensated duty cycle commands that are based on the duty cycle of the first PWM driver signal and the sensed pressure. More specifically, the duty cycle compensator 206 supplies compensated duty cycle commands that vary depending upon the speed error (i.e., the first PWM driver signal duty cycle) and the sensed pressure. Although this functionality may be variously implemented, in the depicted embodiment the duty cycle compensator 206 implements its functionality via a lookup table.

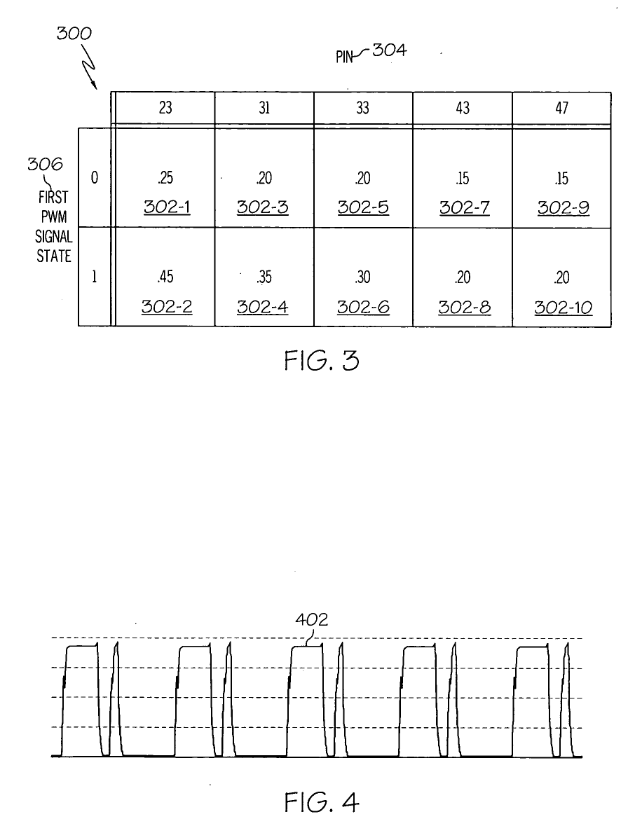

The lookup table 300, an exemplary embodiment of which is depicted in FIG. 3, comprises a plurality of stored compensated duty cycle commands 302 (e.g., 302-1, 302-2, 302-3 . . . 302-10). Each duty cycle command 302 corresponds to a specific duty cycle value, and is associated with a predetermined pressure value 304 and a logic state of the first PWM driver signal 306. In other words, and as is readily apparent from the depicted lookup table 300, there are two compensated duty cycle values associated with each predetermined pressure value 304. One value is a maximum duty cycle command and the other value is a minimum duty cycle command. As is also readily apparent, the maximum and minimum duty cycle commands may differ for each of the associated predetermined pressure values 304. For example, the minimum and maximum duty cycle commands associated with a sensed pressure of 23 psig are 25% and 45% (e.g., 0.25 and 0.45), whereas the minimum and maximum duty cycle commands associated with a sensed pressure of 47 psig are 15% and 20% (e.g., 0.15 and 0.20).

It should be noted that the table 300 depicted in FIG. 3 is merely exemplary, and that it may be implemented with more or less than the number of pressure values 304 that are depicted. Moreover, the specific predetermined pressure values 304 and minimum and maximum duty cycle values 302 associated with each pressure value 304 may vary, as needed or desired to meet operational needs. It is additionally noted that the duty cycle compensator 206 is further configured to implement an interpolation routine for sensed pressures that are not one of the predetermined pressure values 304.

The duty cycle compensator 206, based on the sensed pressure and the first PWM driver signal, indexes the lookup table 300 to supply appropriate compensated duty cycle commands to the second PWM driver 208. As an example, for relatively large speed errors, the first PWM driver signal will have a relatively large duty cycle, which means it will be in a logic-HIGH state (e.g., logical-1) for a greater percentage of time than it will be in a logic-LOW state (e.g., logical-0). Thus, depending upon the sensed pressure, the compensated duty cycle commands supplied by duty cycle compensator 206 will be a maximum duty cycle value for a greater percentage of time than a minimum duty cycle value. Again, the specific maximum and minimum duty cycle values will depend on the sensed pressure.

The second PWM driver 208, which may also be referred to as a solenoid PWM driver or a valve PWM driver, is coupled to receive the compensated duty cycle commands from the duty cycle compensator 206. The second PWM driver 208 is responsive to the compensated duty cycle commands to generate and supply the valve command signals to the control valve 104. The valve command signals also comprise pulses having a duty cycle that varies. The duty cycle of the valve command signals varies based on the compensated duty cycle commands supplied to the duty cycle compensator 206. From the previous description of the duty cycle compensator 206 it may thus be appreciated that the second PWM driver 208 will supply valve command signals having duty cycles that vary between predetermined minimum and maximum values (or interpolated values of these minimum and maximum values), thereby supplying what may be referred to herein as hybrid PWM signals to the control valve 104. An exemplary hybrid PWM signal 402 that may be generated and supplied by the second PWM driver 208 is depicted in FIG. 4.

In addition to each of the major functional blocks described above, the controller 106 may include various other devices to enhance its operation. For example, and with reference once again to FIG. 2, the controller 106 may be implemented with one or more of a gain 212, a first quantizer 214, a second quantizer 216, a filter 218, and an override circuit 220. The gain 212, if included, is disposed between the comparator 202 and the first PWM driver 204 and applies an appropriate gain to the duty cycle commands (e.g., speed error) supplied from the comparator 202.

The first and second quantizers 214, 216 are disposed just upstream of the first PWM driver 204 and the second PWM driver 208, respectively, and are operable to supply discrete values of the duty cycle commands and compensated duty cycle commands, respectively, that each receives. The discrete values that each supplies match allowable possibilities for the update rate of the controller 106. It will be appreciated that if the controller 106 is implemented as an analog device, rather than as a digital device, then the quantizers 214, 216 are not needed.

The filter 218, if included, is disposed between the pressure sensor 122 and the duty cycle compensator 206. In some cases, the sensor signal supplied from the pressure sensor 122 may undesirably include high frequency noise. The filter 218 is coupled to receive the sensor signal, and is operable to filter the high frequency noise from the sensor signal and supply a filtered sensor signal to the duty cycle compensator 206.

The override circuit 220, if included, is coupled between the duty cycle compensator 206 and the second PWM driver 208 and is operable to selectively modify the compensated duty cycle commands supplied to the second PWM driver 208. In the depicted embodiment, the override circuit 220 includes a summer 222 and a saturation block 224. The summer 222 is coupled to receive, from a signal source 226, an override signal, and is further coupled to receive the compensated duty cycle commands from the duty cycle compensator 206. The summer 222 mathematically sums these two signals and supplies a modified command signal to the saturation block 224. The saturation block 224 ensures that a duty cycle command of greater than 100% (e.g., ±1.0) is not exceeded, and supplies the command to the second PWM driver 208. It will be appreciated that the override signal may modify the compensated duty cycle commands so that the control valve 104 is commanded open or commanded closed. It will additionally be appreciated that the external source may be an external device or system, such as a non-illustrated override switch or other non-illustrated control device.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A circuit, comprising:
a first PWM driver adapted to receive duty cycle commands and operable to generate a first PWM driver signal having a duty cycle that varies based on the duty cycle commands;
a duty cycle compensator coupled to receive the first PWM driver signal and a sensor signal representative of a value of a sensed physical parameter, the duty cycle compensator operable to supply compensated duty cycle commands based on the duty cycle of the first PWM driver signal and the value of the sensed physical parameter; and
a second PWM driver coupled to receive the compensated duty cycle commands and operable to generate a hybrid PWM driver signal having a duty cycle that varies based on the compensated duty cycle commands.

2. The circuit of claim 1, wherein:
the duty cycle compensator comprises a lookup table having the compensated duty cycle commands stored therein; and
the duty cycle compensator retrieves compensated duty cycle commands from the lookup table based on the duty cycle of the first PWM driver signal and the value of the sensed physical parameter and supplies the retrieved compensated duty cycle commands to the second PWM driver.

3. The circuit of claim 2, wherein the stored compensated duty cycle commands comprise a minimum duty cycle value and a maximum duty cycle value associated with predetermined values of the sensed physical parameter.

4. The circuit of claim 1, further comprising:
a comparator coupled to receive an input command signal and a feedback signal and operable to supply the duty cycle commands, the duty cycle commands representative of a difference between the input command signal and the feedback signal.

5. The circuit of claim 4, further comprising:
a gain coupled to receive the duty cycle commands from the comparator and apply a gain thereto.

6. The circuit of claim 5, further comprising:
a quantizer coupled to receive the duty cycle commands from the gain amplifier and operable to supply discrete values of the duty cycle commands to the first PWM driver.

7. The circuit of claim 1, further comprising:
a quantizer coupled to receive the compensated duty cycle commands from the duty cycle compensator and operable to supply discrete values of the compensated duty cycle commands to the second PWM driver.

8. The circuit of claim 1, further comprising:
a filter circuit coupled to receive the sensor signal and supply a filtered sensor signal to the duty cycle compensator.

9. A solenoid valve control circuit, comprising:
a first PWM driver adapted to receive duty cycle commands and operable to generate a first PWM driver signal having a duty cycle that varies based on the duty cycle commands;
a duty cycle compensator coupled to receive the first PWM driver signal and a sensor signal representative of a value of a sensed physical parameter, the duty cycle compensator operable to supply compensated duty cycle commands based on the duty cycle of the first PWM driver signal and the value of the sensed physical parameter;
a solenoid PWM driver coupled to receive the compensated duty cycle commands and operable to generate a solenoid PWM driver signal having a duty cycle that varies based on the compensated duty cycle commands;
a solenoid valve coupled to receive the solenoid PWM driver signal and operable, in response thereto, to move between a closed position and an open position at the duty cycle of the solenoid PWM driver signal.

10. The circuit of claim 9, wherein:
the duty cycle compensator comprises a lookup table having the compensated duty cycle commands stored therein; and
the duty cycle compensator retrieves compensated duty cycle commands from the lookup table based on the duty cycle of the first PWM driver signal and the value of the sensed physical parameter and supplies the retrieved compensated duty cycle commands to the second PWM driver.

11. The circuit of claim 10, wherein the stored compensated duty cycle commands comprise a minimum duty cycle value and a maximum duty cycle value associated with predetermined values of the sensed physical parameter.

12. The circuit of claim 9, further comprising:
a comparator coupled to receive an input command signal and a feedback signal and operable to supply the duty cycle commands, the duty cycle commands representative of a difference between the input command signal and the feedback signal.

13. The circuit of claim 12, further comprising:
a gain coupled to receive the duty cycle commands from the comparator and apply a gain thereto.

14. The circuit of claim 13, further comprising:
a quantizer coupled to receive the duty cycle commands from the gain amplifier and operable to supply discrete values of the duty cycle commands to the first PWM driver.

15. The circuit of claim 9, further comprising:
a quantizer coupled to receive the compensated duty cycle commands from the duty cycle compensator and operable to supply discrete values of the compensated duty cycle commands to the second PWM driver.

16. The circuit of claim 9, further comprising:
a filter circuit coupled to receive the sensor signal and supply a filtered sensor signal to the duty cycle compensator.

17. A control system for controlling the speed of a machine, comprising:
a speed sensor operable to sense the speed of the machine and supply a speed feedback signal representative thereof;
a pressure sensor operable to sense a pressure of a fluid used to drive the machine and supply a pressure signal representative thereof;
a valve coupled to receive valve command signals having a duty cycle and operable, in response thereto, to move between an open position and a closed position at the duty cycle of the valve command signals to thereby control fluid flow to the machine; and
a controller coupled to receive a speed command, the speed feedback signal, and the pressure signal and operable, in response thereto, to supply the valve command signals, the controller comprising:
a comparator coupled to receive a speed command and the speed feedback signal and operable, in response thereto, to supply duty cycle commands representative of a difference between the speed command and the speed feedback signal,
a first PWM driver coupled to receive the duty cycle commands and operable to generate a first PWM driver signal having a duty cycle that varies based on the duty cycle commands,
a duty cycle compensator coupled to receive the first PWM driver signal and pressure signal, the duty cycle compensator operable to supply compensated duty cycle commands based on the duty cycle of the first PWM driver signal and the sensed pressure, and
a valve PWM driver coupled to receive the compensated duty cycle commands and operable to supply the valve command signals at a duty cycle that varies based on the compensated duty cycle commands.

18. The system of claim 17, wherein:
the duty cycle compensator comprises a lookup table having the compensated duty cycle commands stored therein; and
the duty cycle compensator retrieves compensated duty cycle commands from the lookup table based on the duty cycle of the first PWM driver signal and the value of the sensed physical parameter and supplies the retrieved compensated duty cycle commands to the second PWM driver.

19. The system of claim 18, wherein the stored compensated duty cycle commands comprise a minimum duty cycle value and a maximum duty cycle value associated with predetermined values of the sensed physical parameter.

20. The system of claim 17, wherein the controller further comprises:
an override circuit adapted to receive an override signal and operable, in response thereto, to modify the compensated duty cycle commands supplied to the valve PWM driver.
